(19) United States
(12) Patent Application Publication
(10) Pub. No.: US 2024/0394717 A1
(43) Pub. Date: Nov. 28, 2024

(54) SYSTEMS AND METHODS FOR OPEN BANKING BASED-SUBSCRIPTION VIA A UNIVERSAL GATEWAY

(71) Applicant: VeriFone, Inc., Wilmington, DE (US)

(72) Inventors: Subadeepak Ilangovan, Herne Bay (GB); Kingshuk Nag, Munich (DE); Kevin Salim, Assendelft (NL); Manjunath Narayan, Amsterdam (NL); James Harrison Bullard, Tampa, FL (US)

(73) Assignee: VeriFone, Inc., Wilmington, DE (US)

(21) Appl. No.: 18/688,581

(22) PCT Filed: Apr. 22, 2022
(86) PCT No.: PCT/US2022/071864

§ 371 Date: Mar. 1, 2024

Related U.S. Application Data
(60) Provisional application No. 63/260,900, filed on Sep. 3, 2021.

(51) Int. Cl. G06Q 20/40; G06Q 40/02

(52) U.S. Cl. CPC G06Q 20/403; G06Q 40/02

(57) ABSTRACT

Computer-implemented methods and systems for open banking-based subscription via a universal gateway are provided. A method includes sending, from a merchant device to a universal gateway, a request for a credit evaluation for a customer of a merchant and receiving, by the merchant device from the universal gateway, responsive to the request from the sending. The credit evaluation for the customer that meets a predefined credit threshold on a subscription for sale by the merchant would result in sending of a request to set up a subscription service instance from the merchant device to the universal gateway. The merchant device is acknowledged by the universal gateway that the subscription service instance is set up to thereby handle recurring payments of the subscription.

### CROSS-REFERENCE TO RELATED APPLICATIONS

This application claims priority to U.S. Patent Application Ser. No. 63/260,900, filed on Sep. 3, 2021, and titled “Universal Token Solution,” which is incorporated by reference in its entirety.

### FIELD OF THE DISCLOSURE

Aspects and implementations of the present disclosure are generally directed to systems and methods for computer-implemented transactions, and more specifically, systems and methods for open banking-based subscription via a universal gateway.

### BACKGROUND

Conventional sales and purchases of goods and services by subscription are usually accomplished through e-commerce transactions. Sales and purchases by subscription are not generally suited for retail merchants due to additional tasks and transactions involved such as a credit screening to determine viability of a subscription contract and handling of recurring payments corresponding to the subscription contract. The additional tasks for subscription sale present numerous challenges for retail merchants primarily because the number of entities involved in subscription sales and due to the maintenance of the subscription. Further challenges for retail merchants arise from heterogeneous interfaces for the numerous entities involved in the subscription transaction. Examples of such entities involved in conventional subscription sales include, but are not limited to, a credit referencing agency, a banking partner, a payment card partner, a customer relationship management (CRM) solution provider, a subscription solution provider, and a payment service provider. Conventionally card information needs to be verified and tokenized for security as serviced by a payment service provider, also referred to as a payment gateway or simply, a gateway, as often used in the payment card industry (PCI). Each of such entities specifies respective service interfaces for retail merchants to adapt in accessing their respective services. It would be desirable to have a solution to facilitate subscription-based sales for retail merchants.

### SUMMARY OF THE DISCLOSURE

The present disclosure is directed to computer-implemented methods and systems for establishing and facilitating recurring transactions between retail merchants and customers via a universal gateway.

In one example, a method is provided, the method including: sending, by one or more processors on a merchant device amongst one or more merchant devices run by a merchant, a request for a credit evaluation for a customer, to a universal gateway operatively coupled to the merchant device via a digital communication network; receiving, by the one or more processors, the credit evaluation for the customer from the universal gateway responsive to the request from the sending; based on ascertaining that the credit evaluation for the customer satisfies a predefined credit threshold on a subscription for sale by the merchant, sending, by the one or more processors, a request to set up a subscription service instance for the subscription between the merchant and the customer to the universal gateway to thereby handle recurring payments corresponding to the subscription by the customer; and receiving, by the one or more processors, from the universal gateway, an acknowledgement that the subscription service instance has been successfully set up corresponding to the request for the subscription service instance.

In an aspect, the method also including: the step of sending the request to set up the subscription service instance also including: prior to the sending the subscription service instance, obtaining respective values for an amount for the recurring payments, due dates for the recurring payments, a bank account number for a debit payment, and a payment card account number for a credit payment based on inputs by the merchant on the merchant device; and prior to the sending the subscription service instance, generating the subscription service instance with the respective values of the amount for the recurring payments, the due dates, the bank account number, and the payment card account number from the obtaining.

In an aspect, the method also including: the step of sending the request for the credit evaluation for the customer also including: prior to the sending the request for the credit evaluation, obtaining respective values for a tax ID of the customer and personal identification information necessary to obtain a credit score report based on inputs on the merchant device as provided by the customer; prior to the sending the request for the credit evaluation, generating the request for the credit evaluation for the customer with the respective values for the tax ID and the personal identification information from the obtaining.

In an aspect, the method also including: the step of sending the request for the credit evaluation for the customer also including: prior to the sending the request for the credit evaluation, obtaining respective values for a bank account number of the customer and personal identification information necessary to obtain bank statements based on inputs on the merchant device as provided by the customer; prior to the sending the request for the credit evaluation, generating the request for the credit evaluation for the customer with the respective values for the bank account number and the personal identification information from the obtaining.

In an aspect, the method also including: based on ascertaining that the credit evaluation for the customer does not satisfies the predefined credit threshold on the subscription for sale by the merchant, prompting the merchant for an input inquiring if the merchant would override the predefined credit threshold for the subscription, by displaying the credit evaluation for the customer along with a request for the input; obtaining, from the merchant, the input indicating that the merchant overrides the predefined credit threshold to thereby sell the subscription to the customer; sending the request to set up a subscription service instance for the subscription between the merchant and the customer to the universal gateway to thereby handle recurring payments corresponding to the subscription by the customer; and receiving, by the one or more processors, from the universal gateway, an acknowledgement that the subscription service instance has been successfully set up corresponding to the request for the subscription service instance.

In an aspect, the method also including: based on ascertaining that the credit evaluation for the customer does not satisfies the predefined credit threshold on the subscription for sale by the merchant, prompting the merchant for an input inquiring if the merchant would override the predefined credit threshold for the subscription, by displaying the credit evaluation for the customer along with a request for the input; obtaining, from the merchant, the input indicating that the merchant would not interfere with the predefined credit threshold thereby not to sell the subscription to the customer; and terminating inquiries on the subscription for the customer with the universal gateway.

In an aspect, the method also including: upon due dates respective to the recurring payments corresponding to the subscription, iteratively receiving a notification with a payment status on a current recurring payment from the universal gateway.

In another example, a method is provided, the method including: receiving, by one or more processors of a universal gateway, a request for a credit evaluation for a customer from a merchant device amongst one or more merchant devices run by a merchant, the merchant device being operatively coupled to the universal gateway via a digital communication network; sending, by the one or more processors, the credit evaluation for the customer to the merchant device, based on completing a back-end processing for the credit evaluation with an open banking partner operatively coupled to the universal gateway; obtaining, by the one or more processors, a request from the merchant device for a subscription service instance to handle recurring payments corresponding to the subscription for the merchant by the customer; and sending, by the one or more processors, an acknowledgement, to the merchant device, that the subscription service instance is successfully set up for handling the recurring payments, based on completing with setup of the subscription service instance for the merchant by the customer based on a universal token integrating payment card information and banking information of the customer.

In an aspect, the request for the credit evaluation includes personal identification information, payment card information, and banking information, respectively corresponding to the customer.

In an aspect, the back-end processing for the credit evaluation including: creating a customer account for the customer; tokenizing the payment card information and the banking information corresponding to the customer into the universal token; inquiring the open banking partner for the credit evaluation for the customer with the universal token; and obtaining the credit evaluation corresponding to the universal token from the open banking partner.

In an aspect, the request for the subscription service instance received from the merchant device to handle the recurring payments corresponding to the subscription for the merchant by the customer includes respective values for an amount for the recurring payments, due dates for the recurring payments, a bank account number for a debit payment, and a payment card account number for a credit payment based on inputs by the merchant on the merchant device as provided by the customer.

In an aspect, the method also including: prior to the sending the acknowledgement of the subscription service instance, creating the subscription service instance based on respective values for an amount for the recurring payments corresponding to the subscription, due dates for the recurring payments, a bank account number for a debit payment for the recurring payments, and a payment card account number for a credit payment for the recurring payments; updating the universal token created upon the credit evaluation with the bank account number and the payment card account number set for the subscription service instance; and associating the customer account for the customer created upon the credit evaluation with the universal token resulting from the updating the universal token.

In an aspect, the method also including: while the subscription is effective, upon respective due dates for each of the recurring payments corresponding to the subscription, iteratively performing: charging, by a subscription service instance for the subscription running on the universal gateway, the open banking partner of the universal token for an amount of a current recurring payment on a scheduled date; receiving, by the subscription service instance, a payment status on the current recurring payment from the open banking partner; based on ascertaining, by the subscription service instance, that the payment status indicates that the current recurring payment had been successfully paid, sending a notification with the payment status on the current recurring payment to the merchant device, by the subscription service instance.

In an aspect, the method also including: while the subscription is effective, upon respective due dates for each of the recurring payments corresponding to the subscription, iteratively performing: charging, by a subscription service instance for the subscription running on the universal gateway, the open banking partner of the universal token for an amount of a current recurring payment on a scheduled date; receiving, by the subscription service instance, a payment status on the current recurring payment from the open banking partner; based on ascertaining, by the subscription service instance, that the payment status indicates that the current recurring payment had not been successfully paid, charging the payment network of the universal token for the amount of the current recurring payment by the subscription service instance; receiving, by the subscription service instance, a credit payment status on the current recurring payment from the payment network of the universal token; and sending a notification with the credit payment status on the current recurring payment to the merchant device.

In an aspect, the method also including: while the subscription is effective, upon respective due dates for each of the recurring payments corresponding to the subscription, iteratively performing: charging, by a subscription service instance for the subscription running on the universal gateway, the open banking partner of the universal token for an amount of a current recurring payment on a scheduled date; receiving, by the subscription service instance, a debit payment status on the current recurring payment from the open banking partner; based on ascertaining, by the subscription service instance, that the debit payment status indicates that the current recurring payment had not been successfully paid, charging the payment network of the universal token for the amount of the current recurring payment by the subscription service instance; receiving, by the subscription service instance, a credit payment status on the current recurring payment from the payment network of the universal token; and sending a notification with the debit payment status and the credit payment status on the current recurring payment to the merchant device.

In an aspect, the method also including: while the subscription is effective, upon respective due dates for each of the recurring payments corresponding to the subscription, iteratively performing: charging, by a subscription service instance for the subscription running on the universal gateway, an alternative payment account of the customer including a reward point account and a gift card account as offered by the merchant or another merchant affiliated for payment exchange of the universal token for an amount of a current recurring payment on a scheduled date, wherein the universal token includes the alternative payment account of the customer as provided by the customer or the merchant in relation with the subscription service instance.

In still another example, a system is provided, the system including: a merchant device amongst one or more merchant devices for a merchant to access a payment service, wherein the merchant device is located at a retail store of the merchant, and wherein the merchant provides a retail product for sale to be purchased by a customer at the retail store by a subscription associated with recurring payments; a universal gateway configured to provide, to the merchant device, the payment service, a subscription service to handle the recurring payments corresponding to the subscription, a token service to integrate financial information of the customer into a universal token for credit evaluation and payments, and a customer service to create and manage a customer account for the customer with respect to the subscription and the universal token; one or more payment networks operatively coupled to the universal gateway for credit transactions requested from the merchant device; and one or more open banking partners operatively coupled to the universal gateway for banking transactions requested from the merchant device.

In an aspect of the system, the universal gateway is also configured to: charge the open banking partner of the universal token for an amount of a current recurring payment on a scheduled date while the subscription is effective; receive a payment status on the current recurring payment from the open banking partner; based on ascertaining that the payment status indicates that the current recurring payment had been successfully paid, send a notification with the payment status on the current recurring payment to the merchant device.

In an aspect of the system, the universal gateway is also configured to: charge the open banking partner of the universal token for an amount of a current recurring payment on a scheduled date while the subscription is effective; receive a payment status on the current recurring payment from the open banking partner; based on ascertaining that the payment status indicates that the current recurring payment had not been successfully paid, charge the payment network of the universal token for the amount of the current recurring payment; receive a credit payment status on the current recurring payment from the payment network of the universal token; and send a notification with the credit payment status on the current recurring payment to the merchant device.

In an aspect of the system, the universal gateway is also configured to: charge the open banking partner of the universal token for an amount of a current recurring payment on a scheduled date while the subscription is effective; receive a debit payment status on the current recurring payment from the open banking partner; based on ascertaining that the debit payment status indicates that the current recurring payment had not been successfully paid, charge the payment network of the universal token for the amount of the current recurring payment; receive a credit payment status on the current recurring payment from the payment network of the universal token; and send a notification with the debit payment status and the credit payment status on the current recurring payment to the merchant device.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram for functional components of a subscription system based on open banking according to the present disclosure.

FIG. 2 is a flowchart illustrating exemplary steps of the merchant device in the subscription system according to the present disclosure.

FIG. 3 is a flowchart illustrating exemplary steps of the universal gateway in the subscription system according to the present disclosure.

FIG. 4 is a communication sequence chart for the universal gateway in the subscription system according to the present disclosure.

FIG. 5 is a flowchart illustrating exemplary steps of the subscription service in the subscription system according to the present disclosure.

FIG. 6 is a communication sequence chart for the subscription service in the subscription system according to the present disclosure.

FIG. 7 depicts an exemplary schematic diagram of a payment device, focusing primarily on processing and components useful for completing the functions and methods described in the present disclosure.

### DETAILED DESCRIPTION OF EMBODIMENTS

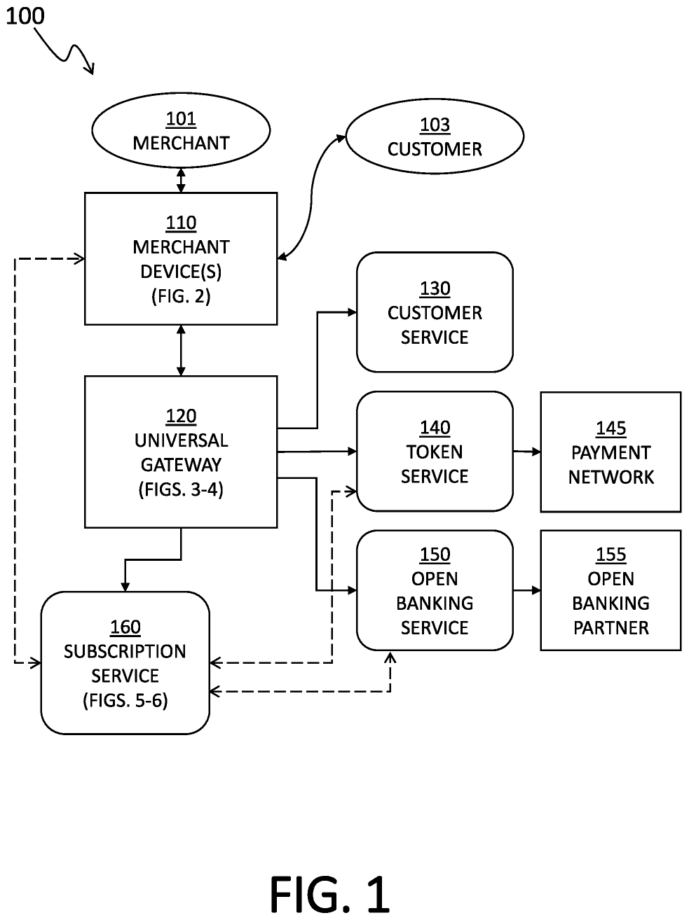

The present disclosure is directed to methods and systems for automatically establishing and subsequently facilitating a subscription relationship between retail merchants and customers for recurring transactions by use of an integrated gateway. The integrated gateway is operatively coupled to banks and payment service providers such that the integrated gateway offers retail merchants a streamlined interface to the banks and the payment service providers. The integrated gateway can also provide additional services associated with the subscription, including, but not limited to, a credit status check to screen customers for the subscription, a customer relation management regarding the subscription, a payment card life cycle management for a payment card registered for the subscription, an open banking use and access for credit screening and recurring payments, and a subscription management including recurring payment handling. The following description should be read in view of FIGS. 1-7.

FIG. 1 is a diagram for functional components of a subscription system 100 based on universal gateway services according to the present disclosure.

The subscription system 100 includes a merchant device 110 accessing a universal gateway 120 that is operatively coupled to a payment network 145 and to an open banking partner 155. The merchant device 110, the universal gateway 120, the payment network 145, and the open banking partner 155 are operatively coupled with one another via one or more digital communication networks such as the Internet, Virtual Private Networks (VPNs), in various physical formats including but not limited to, Ethernet cable network, optical cable network, or a wireless network. The merchant device 110 represents one or more merchant devices accessing the universal gateway 120. The payment network 145 represents a plurality of payment networks that are operatively coupled to, and accordingly, accessible through the universal gateway 120. The open banking partner 155 represents a plurality of open banking partners that are operatively coupled to, and accordingly, accessible through the universal gateway 120.

A merchant 101 and a customer 103 access the merchant device 110 to set up a subscription relationship for goods/services provided by the merchant 101 to the customer 103 in exchange of a series of recurring payments. The merchant 101 is a retailer having the merchant device 110 at a physical retail store for business. Examples of goods/services suitable for subscription-based retail sale include, but are not limited to, followings: mobile phones with mobile phone service contract, motor vehicles, jewelry, or any other highly-priced retail products; memberships from a gym or a sports club, periodic publications such as magazines or newspapers from a bookstore or a newsstand; payday loans or other financial transactions at a pawn shop; and any retail products that can be regularly bought and sold at a retail store such as grocery, medicine, seasonal items, or the similar.

In this disclosure, the terms “subscription relationship,” “subscription,” “subscription contract,” and “recurring transactions” are used interchangeably to indicate an agreement to sale and purchase goods/services for recurring payments as described above.

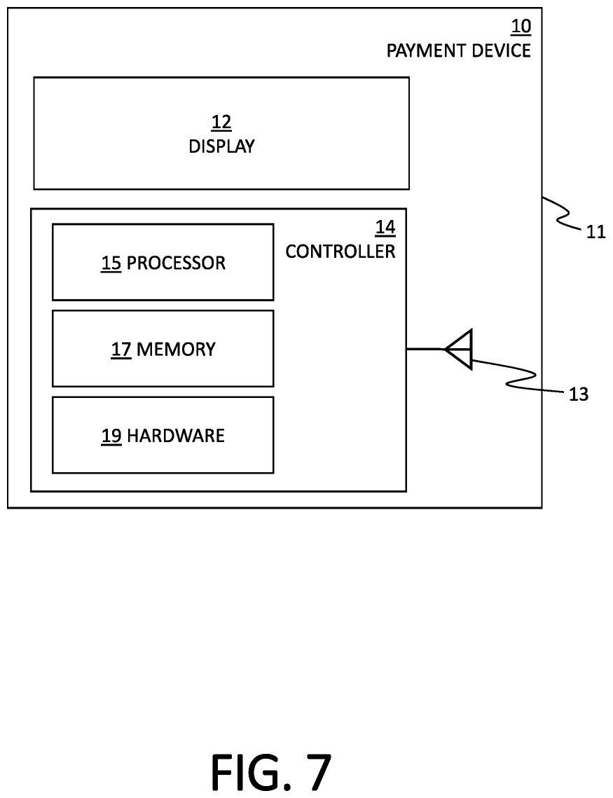

The merchant device 110 is an authorized piece of hardware for the merchant 101 to access the universal gateway 120 for a standard payment service as well as a customer service 130, a token service 140, an open banking service 150, and a subscription service 160. The universal gateway 120 provides an integrated interface to all services listed above necessary for the merchant 101 via the merchant device 110 to facilitate and to manage a subscription, unlike in conventional subscription system with multiple channels with heterogeneous interfaces for the merchant 101. The merchant device 110 can be implemented with any type of credit/debit card reader with magnetic strip and/or smart chip or ways to input to the card information, a secure connectivity to the universal gateway 120, and a display operatively coupled to the card reader. Examples of the merchant device 110 include, but are not limited to, a card reader accessory for mobile phones, a payment device 10 of FIG. 7. The merchant device 110 can also be personal/mobile device of the merchant 101 or any other type of electronic device that can gain access and provide payment information to the universal gateway 120 and performs any of tasks presented herein.

In certain embodiments of the present disclosure, the customer service 130, the token service 140, the open banking service 150, and the subscription service 160 are respective software and/or hardware modules that communicate with one another via application programming interface (API) supported by the universal gateway 120. The merchant device 110 can be registered to subscribe one or more services amongst the customer service 130, the token service 140, the open banking service 150, and the subscription service 160 for a fee or respective fees prior to making requests on the subscription relationship between the merchant 101 and the customer 103.

In certain embodiments of the present disclosure, the customer 103 can access the merchant device 110 directly by user interfaces of the merchant device 110 or by use of one or more personal devices of the customer 103 in order to authorize usages of the financial information of the customer 103 for the subscription relationship with the merchant 101. For example, the customer 103 can provide a direct input on the merchant device 110 by tapping buttons on a keypad of the merchant device 101, by clicking checkboxes on a touchscreen of the merchant device 101, or by scanning a quick response (QR) code displayed on the merchant device 110 directed to an authorization page, a terms and privacy document, etc., with a smartphone of the customer 103.

The customer service 130, as facilitated by the universal gateway 120, provides various services for the customer 103 in relation with the subscription, including but not limited to, a customer relation management for the customer 103 regarding the subscription for payment reminders and payment notifications on recurring payments of the subscription, and a payment card life cycle management for a payment card of the customer 103 provided for the subscription. The customer service 130 generates an account for the customer 103 based on information provided upon receiving a credit screening request for the customer 103 if the card information changes for reasons of loss, theft, renewal, or a new card registered by the customer 103 during the course of the subscription. The customer 103 provides bank account information, payment card information, and other personal information, upon applying for the subscription relationship, to the universal gateway 120 via the merchant device 110.

The token service 140, as facilitated by the universal gateway 120, tokenizes the bank account information, the payment card information, and other personal information of the customer 103 submitted to apply for the subscription, as registered with the customer service 130. By tokenizing financial information of the customer 103, the universal gateway 120 can access and be paid from the payment network 145 and the open banking partner 155 for each of the recurring payments by use of a token without the financial information of the customer 103 for added security and convenience for the merchant 101 by streamlining interactions of the merchant 101 to have the subscription in place and to manage the subscription. In this disclosure, the term “token” indicates a value provided by hardware or software application for authentication of a payment by credit card transaction, which is not a card number for security, according to the ordinary meaning of the term. In this disclosure, the term “universal token” indicates an encrypted value provided by hardware or software application for authentication of a payment by credit card transaction and by bank transaction as well as for authentication to use a customer account information in relation with a recurring transaction that had been registered for a customer including customer communication on all aspects of the recurring transaction and credit card lifecycle management, as described for example in U.S. Patent Application No. 63/260,900, entitled “Universal Token Solution,” the contents of which are incorporated by reference herein.

The open banking service 150, as facilitated by the universal gateway 120, provides an access to the open banking partner 155 to handle transactions of credit screening inquired by merchants and debit payments from an account of retail customers. The open banking partner 155 has been identified from the financial information provided by the customer 103 for credit screening and the recurring payments to the merchant 101 for the subscription.

The subscription service 160, as facilitated by the universal gateway 120, establishes the subscription relationship between the merchant 101 and the customer 103 upon being requested from the merchant device 110 based on details of the subscription relationship, including but not limited to, an amount for the recurring payments, due dates, a pay period, a payment card account number for a credit payment and a bank account number for a debit payment, which will be encoded into a universal token by the token service 140 for the subscription between the merchant 101 and the customer 103. In setting up the subscription relationship between the merchant and the customer 103, the subscription service 160 correlates the token service 140 and the open banking service 150 via the universal token with respect to information to handle recurring payments of the subscription for the customer 103. While the subscription relationship is effective, the subscription service 160 automatically handled the recurring payments according to terms of the subscription relationship using the universal token corresponding to the subscription. The subscription service 160 subsequently notifies the merchant device 110 with a payment status of each recurring payment.

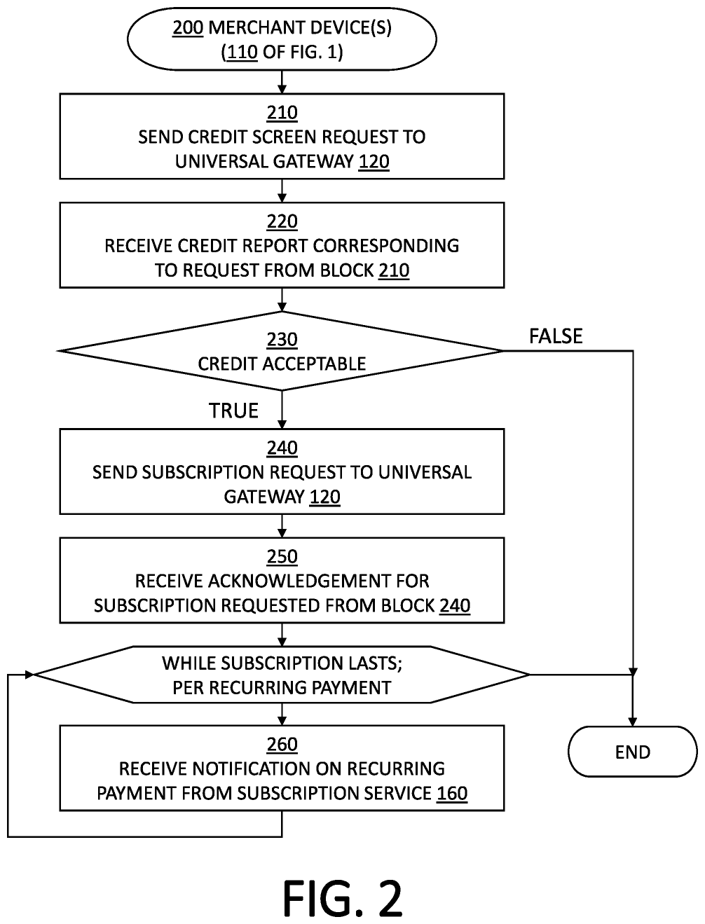

FIG. 2 is a flowchart 200 illustrating exemplary steps of the merchant device 110 in the subscription system 100 according to the present disclosure.

As noted above, the merchant device 110 is representative of the one or more merchant devices that can be used in performing following tasks but is not limited to singular device used by the merchant 101. The tasks presented in the flowchart 200 can be grouped into three sets of tasks in relation with progression of the subscription relationship. The merchant device 110 performs blocks 210 through 230 in preparation of the subscription relationship. The merchant device 110 performs blocks 240 and 250 to set up the subscription relationship with the universal gateway 120. The merchant device 110 performs block 260 while the subscription relationship is effective.

In block 210, the merchant device 110 sends a request for credit screening of the customer to the universal gateway 120. The merchant device 110 sends information of the customer 103 on details of identification number such as tax ID or a bank account information as provided and authorized by the customer 103 along with the request for credit screening. Then, the merchant device 110 proceeds with block 220.

In this disclosure, all requests and responses/acknowledgements/reports corresponding to respective requests indicate communication between software/hardware modules in accordance with an application programming interface (API) of the universal gateway 120, including but not limited to, call or any other invocation of a necessary module with a preconfigured parameter list and respective values corresponding to parameters of the parameter list.

In block 220, the merchant device 110 receives a credit report of the customer 103 corresponding to the request for credit screening sent from block 210. Then, the merchant device 110 proceeds with block 230.

In block 230, the merchant device 110 determines whether a credit of the customer 103 reported from block 220 is acceptable for the merchant 101 to establish the subscription relationship for a sale of goods/services by subscription. Based on various aspects of the subscription relationship including, but not limited to, a price range of the goods/services subject to the subscription and a length of subscription period, a certain threshold for the credit can be preconfigured and automatically applied. Alternatively, or in combination with the preconfigured threshold, the merchant 101 can interactively input whether the credit of the customer is acceptable to establish the subscription relationship. For example, a certain credit assessment for the customer 103 can be accepted to purchase a mobile phone with recurring payment agreements but not for a motor vehicle. If the merchant device 110 determines, either automatically or based on inputs from the merchant 101, that the credit of the customer 103 is acceptable to establish the subscription relationship of interest, the merchant device 110 proceeds with block 240. If the merchant device 110 determines that the credit of the customer 103 is not acceptable to establish the subscription relationship of interest, the merchant device 110 terminates processing the subscription relationship between the merchant 101 and the customer 103.

In block 240, the merchant device 110 sends a subscription service request to universal gateway 120 to handle the subscription relationship between the merchant 101 and the customer 103 for the recurring payments, as the credit of the customer 103 had been determined acceptable for the subscription from block 230. A certain payment transaction for payment of a deposit or a first month payment can be previously performed, or the subscription service request include the deposit or a first month payment as indicated from a pay period and/or a due date for the subscription relationship such that the subscription service 160 can handle the deposit or a first month payment. Then, the merchant device 110 proceeds with block 250.

In block 250, the merchant device 110 receives an acknowledgement that the subscription service is set for the subscription relationship as requested from block 240, either from the universal gateway 120 or from the subscription service 160. Then, the merchant device 110 proceeds with block 260.

Block 260 is iterated per pay period while the subscription relationship lasts, subsequent to setting up the subscription relationship in blocks 240 and 250.

In block 260, the merchant device 110 receives a notification on a status of the recurring payment specified in the subscription relationship between the merchant 101 and the customer 103 from the subscription service 160. Due to the time lapse and/or a type of the notification, the merchant device 110 in block 260 that receives the notification can be another instance/form of the merchant device 110 distinctive from the merchant device 110 that had performed blocks 210 through 240 or blocks 210 through 250 that had been used in setting up the subscription relationship. For example, an email account serviced on a mobile phone of the merchant 101 can be used to receive the notification on the status of the recurring payment from block 260.

The subscription relationship can be terminated by the customer 103 or for any other reason according to the terms of the subscription relationship. Then, the merchant device 110 would not receive any more notification on the recurring payments as the subscription service 160 terminates the subscription as well. A termination of the subscription relationship and the subscription service 160 handling the recurring payments therefrom can also be notified to the merchant device 110 and acknowledged according to the terms on servicing the subscription relationship as configured for the subscription service 160.

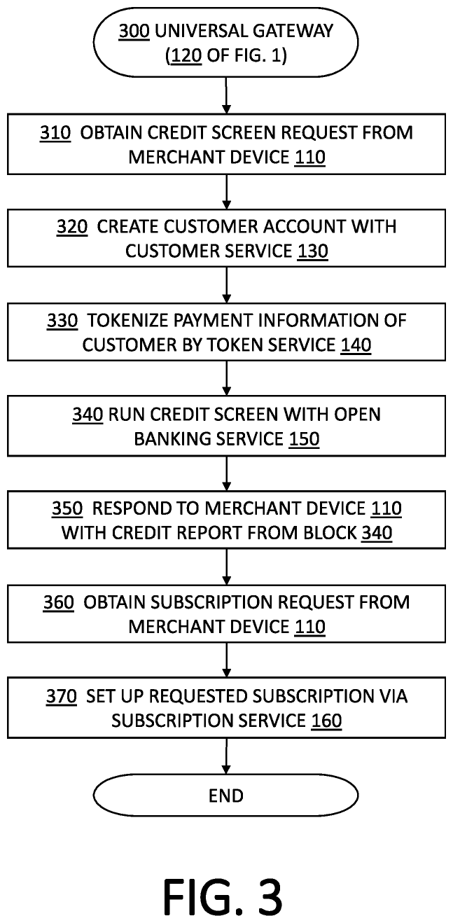

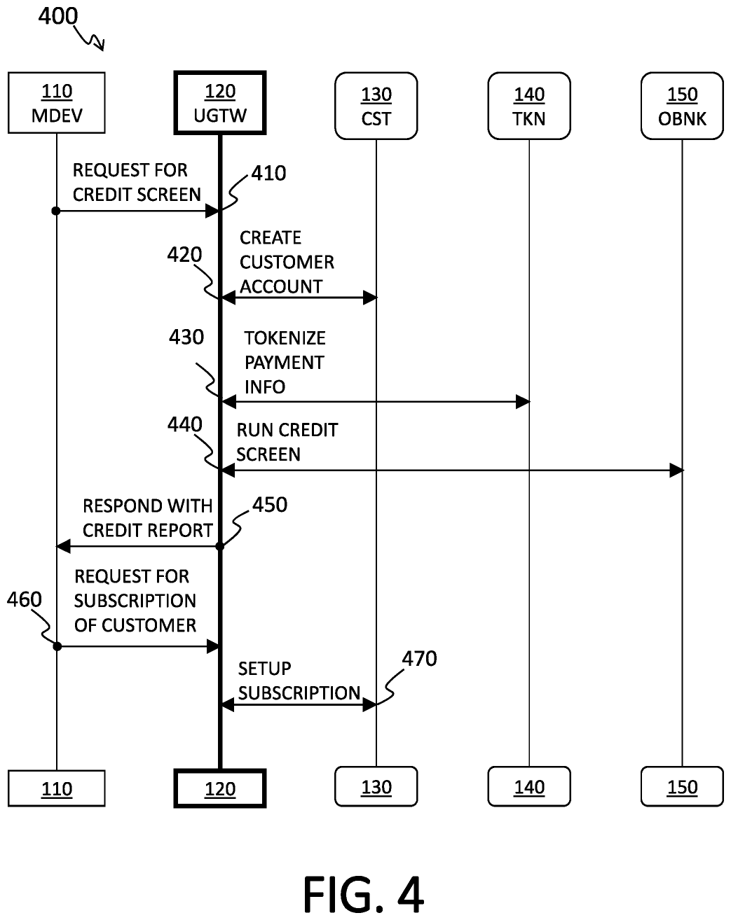

FIG. 3 is a flowchart 300 illustrating exemplary steps of the universal gateway 120 in the subscription system 100 according to the present disclosure. FIG. 4 is a communication sequence chart 400 for the universal gateway 120 in the subscription system according to the present disclosure.

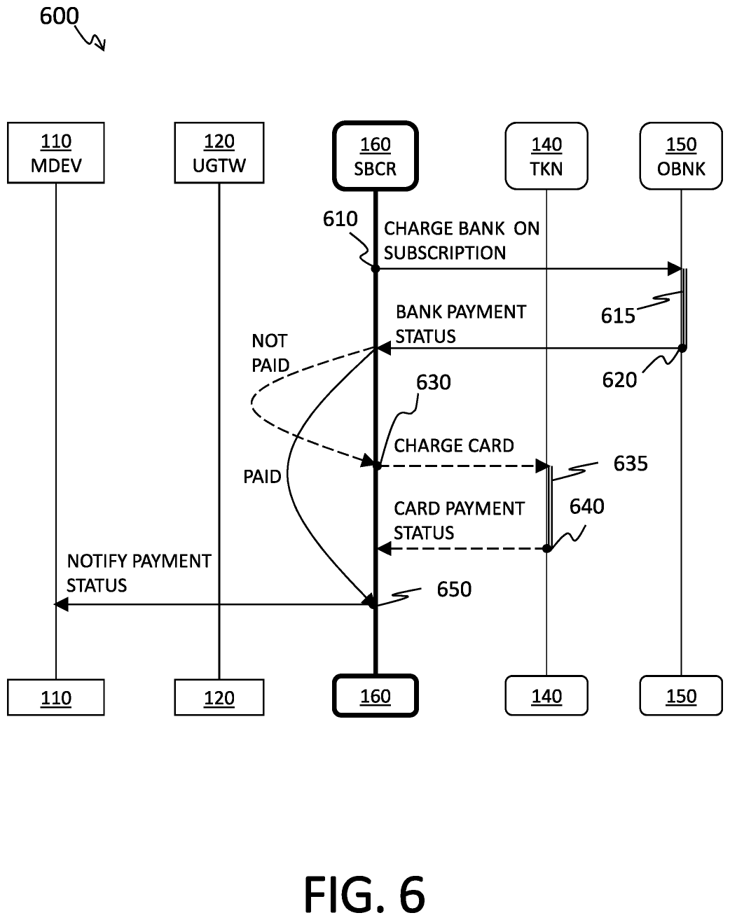

The tasks presented in the flowchart 300 can be grouped into two sets of tasks in relation with progression of the subscription relationship. The universal gateway 120 performs blocks 310 through 350 in preparation of the subscription relationship, primarily for the credit screening as performed in between blocks 210 and 220 of FIG. 2 by the merchant device 110, as described in FIG. 4 and corresponding description. The universal gateway 120 performs blocks 360 and 370 to set up the subscription relationship as requested from the merchant device 110, as described in FIG. 6 and corresponding description. The universal gateway 120 will not be actively engaged any further after the customer service 130, the token service 140, the open banking service 150, and the subscription service 160 had become operational for the subscription relationship between the merchant 101 and the customer 103.

In block 310, the universal gateway 120 obtains the request for credit screening sent by the merchant device 110 at block 210 of FIG. 2. The merchant device 110 at block 210 of FIG. 2 is a transmitter of communication 410 in FIG. 4 and the universal gateway 120 at block 310 of FIG. 3 is a receiver of communication 410 in FIG. 4. As noted above, identification and financial information of the customer 103 are included in the request for credit screening. Then, the universal gateway 120 proceeds with block 320.

In block 320, the universal gateway 120 sends a request for creating a customer account of the customer 103 to the customer service 130. A feedback loop on the customer account request between the universal gateway 120 and the customer service 130 is not shown for brevity. Upon being requested, the customer service 130 creates the customer account and then acknowledges back to the universal gateway 120 that the customer account has been created. In FIG. 4, bidirectional communication 420 denotes the request for and the feedback on the customer account request between the universal gateway 120 and the customer service 130. Upon receiving the acknowledgement of the customer account from the customer service 130, the universal gateway 120 proceeds with block 330.

In certain embodiments of the present disclosure, the customer 103 can already have the customer account by the customer service 130 based on a previous subscription with another merchant. The universal gateway 120 will integrate multiple subscriptions sold by respective merchants for the customer 103 to handle respective recurring payments for the multiple subscriptions, which will benefit the customer 103 by coherent payment reminders and subscription handling for the multiple subscriptions. Further, the universal gateway 120 benefits the customer 103 by extending payment options with a certain merchant issued gift cards and reward points for paying another subscription from an affiliated merchant. As all subscriptions handled by the customer service 130 of the universal gateway 120, the customer service 130 can provide financial guidance based on a spending trend of the customer 103 as represented the recurring payments respective to the subscriptions of the customer 103.

In block 330, the universal gateway 120 sends a request for tokenizing payment information of the customer 103 to the token service 140. As noted above, the payment information of the customer 103 had been received with the request for credit screening in block 310. A feedback loop on the tokenization request between the universal gateway 120 and the token service 140 is not shown for brevity. Upon being requested, the token service 140 tokenizes the payment information of the customer 103 for the payment network 145 and then acknowledges back to the universal gateway 120 that the payment information of the customer 103 has been tokenized for future use. In FIG. 4, bidirectional communication 430 denotes the request for and the feedback on tokenizing the payment information between the universal gateway 120 and the token service 140. Upon receiving the acknowledgement of the token from the token service 140, the universal gateway 120 proceeds with block 340.

In block 340, the universal gateway 120 sends a request for credit screening of the customer 103 to the open banking service 150. As noted above, the bank information of the customer 103 had been received with the request for credit screening in block 310. A feedback loop on the credit screening request between the universal gateway 120 and the open banking service 150 is not shown for brevity. Upon being requested, the open banking service 150 runs a credit screening with the open banking partner 155 and then reports a result for credit screening back to the universal gateway 120. Exemplary credit screening results include but are not limited to, a credit score by one of credit reporting agencies, bank statements for a predefined period, an average account balance for three months, etc. In FIG. 4, bidirectional communication 440 denotes the request for and the feedback on credit screening of the customer 103 between the universal gateway 120 and the open banking service 150. Upon receiving the credit screening result from the open banking service 150, the universal gateway 120 proceeds with block 350.

In block 350, the universal gateway 120 sends the result of credit screening from block 340 to the merchant device 110, in response to the credit screening request obtained in block 310. The universal gateway 120 at block 350 of FIG. 3 is a transmitter of communication 450 in FIG. 4 and the merchant device 110 at block 220 of FIG. 2 is a receiver of communication 450 in FIG. 4. Then, the universal gateway 120 proceeds with block 360.

Alternatively, subsequent to block 350, the universal gateway 120 can terminate processing requests related to the subscription relationship between the merchant 101 and the customer 103, if the merchant device 110 does not send out the request to set up the subscription relationship within a preconfigured duration from reporting the credit screening result, for example, presuming that the credit screening result was not acceptable for the subscription relationship, corresponding to the merchant device 110 after block 230 of FIG. 2, which terminates processing the subscription relationship for an unacceptable credit screening result.

In block 360, the universal gateway 120 obtains a request for setting up the subscription relationship between the merchant 101 and the customer 103, after the merchant device 110 had sent the subscription relationship request out to the universal gateway 120 at block 240 of FIG. 2. As noted above, details on recurring payments such as payment amount, due dates, pay period, and other information specific to the subscription relationship that had not been provided in block 310 for the credit screening would be made available to set up the subscription service 160 for the subscription relationship. In this disclosure, the subscription service 160 for the subscription relationship between the merchant 101 and the customer 103 can be more specifically referred to as a “subscription service instance.” The merchant device 110 at block 240 of FIG. 2 is a transmitter of communication 460 in FIG. 4 and the universal gateway 120 at block 360 of FIG. 3 is a receiver of communication 460 in FIG. 4. Then, the universal gateway 120 proceeds with block 370.

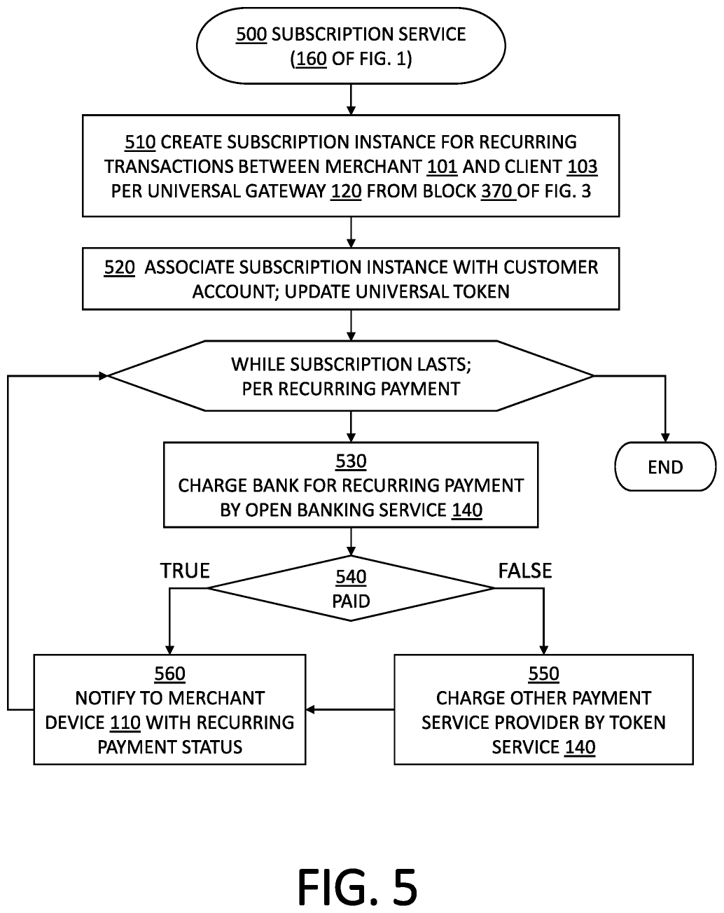

In block 370, the universal gateway 120 sets up the subscription relationship between the merchant 101 and the customer 103 via the subscription service 160 based on the information made available for the subscription relationship, including the token for the payment information and the bank information to handle the recurring payments specified in the subscription relationship. A feedback loop on the subscription relationship setup request between the universal gateway 120 and the subscription service 160 is not shown for brevity. Upon being requested, the subscription service 160 establishes an instance of service to handle the subscription relationship between the merchant 101 and the customer 103 for recurring payments and then acknowledges back to the universal gateway 120 that the subscription relationship has been set. In FIG. 4, bidirectional communication 470 denotes the request for and the feedback on setting up the subscription relationship between the universal gateway 120 and the subscription service 160 at block 510 of FIG. 5 as below. Upon receiving the acknowledgement of the subscription relationship from the subscription service 160, the universal gateway 120 forwards the feedback on the subscription relationship status to the merchant device 110 or terminates processing the subscription, based on system configuration for the subscription service 160.

FIG. 5 is a flowchart 500 illustrating exemplary steps of the subscription service 160 in the subscription system 100 according to the present disclosure. FIG. 6 is a communication sequence chart 600 for the subscription service 160 in the subscription system 100 according to the present disclosure.

In block 510, the subscription service 160 creates a subscription instance for the subscription relationship, as commanded by the universal gateway 120 from block 370 of FIG. 3, also shown in communication 470 of FIG. 4. The universal gateway 120 relays details of the subscription relationship between the merchant 101 and the customer 103 obtained at block 360 of FIG. 3, as the merchant device 110 had sent the subscription request at block 240 of FIG. 2, also shown in communication 460 of FIG. 4. Then, the subscription service 160 proceeds with block 520.

In block 520, the subscription service 160 associates the subscription instance for the subscription relationship with the customer account for the customer 103 as generated by the customer service 130 according to the request by the universal gateway 120 in block 320 of FIG. 3, also shown in communication 420 and a corresponding feedback loop therefrom as described in FIG. 4. The subscription service 160 can update the universal token having integrated the payment card information and the banking information for the customer 103 provided upon the credit screening, if the subscription service request includes replaced or additional information on the payment card information and the banking information in comparison to the universal token created upon the credit screening. Then, the subscription service 160 proceeds with block 530.

Upon concluding block 520, the subscription service 160 is established with all information necessary to handle recurring payments of the subscription relationship, by use of a universal token integrating access channels to the customer service 130, the token service 140, the open banking service 150, and the subscription service 160. In block 520, the subscription service 160 would verify respective accesses via the universal token to the customer account, to the payment network 145, and to the open banking partner 155 that would be accessed for the recurring payments of the customer 103 under the terms of the subscription relationship.

The subscription service performs blocks 530 through 560 for each recurring payment while the subscription relationship lasts, subsequent to setting up the subscription instance in blocks 510 and 520. Blocks 510 and 520 are likely to be performed at the time of purchase of the subscription but blocks 530 through 560 would be performed much later at each due date or other scheduled payment date once in a payment period, often a month, 3 months, or 6 months.

In block 530, the subscription service 160 charges the open banking service 150 for a current recurring payment by use of the open banking service 140 as accessed via the universal token. As noted above, the customer 103 has an account with the open banking partner 155 accessible via the open banking service 150 and had provided banking details for credit screening and payment installment to purchase the subscription. Communication 610 of FIG. 6 also shows a payment request sent from the subscription service 160 to the open banking service 150. The open banking service 150 processes the payment request as shown in FIG. 6, which represents a back-end banking transaction 615 to process the amount for the current recurring payment by transferring the fund from a bank for the customer 103 and by receiving the fund at a bank for the merchant 101, where both banks are accessible via the open banking service 150. Upon conclusion of the back-end banking transaction 615, the open banking service 150 sends a feedback indicating a status of the bank payment, denoted as communication 620 of FIG. 6. Then, the subscription service 160 proceeds with block 540.

In block 540, the subscription service 160 determines if the payment request for the current recurring payment to the open banking service 150 from block 530 had been successful. If the subscription service 160 determines that the current recurring payment had been paid as indicated by the status of the bank payment as shown in communication 620 of FIG. 6, then the subscription service 160 proceeds with block 560. If the subscription service 160 determines that the current recurring payment had not been paid, then the subscription service 160 proceeds with block 550.

In block 550, the subscription service 160 invokes the token service 140 with the universal token to charge the current recurring payment from other payment service provider from the payment network 145, as the bank payment has been unsuccessful. Communication 630 of FIG. 6 represents the subscription service 160 requesting payment from a payment card service provider via the token service 140. The token service 140 processes the payment request as shown in FIG. 6, which represents a back-end card transaction 635 to process the amount for the current recurring payment by transferring the fund from a payment card service provider registered for the customer 103 and by receiving the fund at the bank for the merchant 101, where both the payment card service provider and the bank for the merchant 101 are accessible via the token service 140 and the universal token set for the customer 103 from the payment network 145. Upon conclusion of the back-end car transaction 635, the token service 140 sends a feedback indicating a status of the card payment, denoted as communication 640 of FIG. 6. Then, the subscription service 160 proceeds with block 560.

By use of the universal token as provided by the universal gateway 120, the subscription service 160 will be able to follow up with any changes in payment card information and dynamically adjust the payment card information to handle the recurring payments. Accordingly, it is more likely to have the recurring payment paid successfully than conventional subscription service that charges a payment card information as provided and fails if there is any change with the payment card information.

In block 560, the subscription service 160 notifies the merchant device 110 with the status of the bank payment from block 540 or the status of the card payment from block 550 for the current recurring payment, indicating whether the current recurring payment has been made by the customer 103 by the bank payment or by the card payment, or if the current recurring payment has not been made at all either way, also shown in communication 650 of FIG. 6. Then, the subscription service 160 terminates processing the current recurring payment and loops back to block 530 for a next recurring payment.

Prior to a next scheduled payment date for the next recurring payment, the subscription relationship can be terminated by the customer 103 or for any other reason according to the terms of the subscription relationship. With an exception of a certain preconfigured processing time for cancelation, which may or may not be refunded to the customer 103 per residual obligations based on the subscription relationship between the merchant 101 and the customer 103, the subscription service 160 then terminates processing the next recurring payments for the subscription instance.

FIG. 7 depicts an exemplary schematic diagram of a payment device 10, focusing primarily on processing and components useful for completing the functions and methods in place of the merchant device 110 described in this disclosure. As shown, the payment device 10, in this example, includes a housing 11, a display 12, an antenna 13, and a controller 14. To focus more on the pertinent features of payment device 10, not shown in FIG. 7 are components for receiving payments via magnetic stripe, a chip, or Near Field Communication (NFC), components for connection to a network, such as a payment processing network, components for receiving power (e.g., a power supply), etc., which can be present in various examples of the payment device 10.

The controller 14 can include one or more processors 15, and any associated hardware 17, configured to execute at least one step (e.g., the steps described in connection with the method described herein) stored in a non-transitory storage medium, such as a memory 17, to perform the various functional components described in this disclosure. For example, the controller 14 can be a microprocessor or microcontroller executing steps stored in the memory 17 (either as firmware or software). The antenna 13, as described above, can be any suitable antenna for determining a range to a payment transceiver. Although the antenna 13 is shown disposed within the housing 11, it should be understood that in, alternative examples, the antenna 13 can be disposed on the housing 11, extending from the housing 11, or remote from the housing 11. Further, in various alternative examples, as described above, the controller 14 can receive signals from multiple antennas and/or transmit data encoded by the processors 15 in communication with one or more antennas. The display 12 can be employed to notify a user of information such as totals before a payment is approved, and status updates on the processing, such as approval or denial.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled. While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer implemented method comprising:
sending, by one or more processors on a merchant device amongst one or more merchant devices run by a merchant, a request for a credit evaluation for a customer, to a universal gateway operatively coupled to the merchant device via a digital communication network;
receiving, by the one or more processors, the credit evaluation for the customer from the universal gateway responsive to the request from the sending;
based on ascertaining that the credit evaluation for the customer satisfies a predefined credit threshold on a subscription for sale by the merchant, sending, by the one or more processors, a request to set up a subscription service instance for the subscription between the merchant and the customer to the universal gateway to thereby handle recurring payments corresponding to the subscription by the customer; and
receiving, by the one or more processors, from the universal gateway, an acknowledgement that the subscription service instance has been successfully set up corresponding to the request for the subscription service instance.

2. The computer implemented method of claim 1, the step of sending the request to set up the subscription service instance further comprising:
prior to the sending the subscription service instance, obtaining respective values for an amount for the recurring payments, due dates for the recurring payments, a bank account number for a debit payment, and a payment card account number for a credit payment based on inputs by the merchant on the merchant device; and
prior to the sending the subscription service instance, generating the subscription service instance with the respective values of the amount for the recurring payments, the due dates, the bank account number, and the payment card account number from the obtaining.

3. The computer implemented method of claim 1, the step of sending the request for the credit evaluation for the customer further comprising:
prior to the sending the request for the credit evaluation, obtaining respective values for a tax ID of the customer and personal identification information necessary to obtain a credit score report based on inputs on the merchant device as provided by the customer;
prior to the sending the request for the credit evaluation, generating the request for the credit evaluation for the customer with the respective values for the tax ID and the personal identification information from the obtaining.

4. The computer implemented method of claim 1, the step of sending the request for the credit evaluation for the customer further comprising:
prior to the sending the request for the credit evaluation, obtaining respective values for a bank account number of the customer and personal identification information necessary to obtain bank statements based on inputs on the merchant device as provided by the customer;
prior to the sending the request for the credit evaluation, generating the request for the credit evaluation for the customer with the respective values for the bank account number and the personal identification information from the obtaining.

5. The computer implemented method of claim 1, further comprising:
based on ascertaining that the credit evaluation for the customer does not satisfies the predefined credit threshold on the subscription for sale by the merchant, prompting the merchant for an input inquiring if the merchant would override the predefined credit threshold for the subscription, by displaying the credit evaluation for the customer along with a request for the input;
obtaining, from the merchant, the input indicating that the merchant overrides the predefined credit threshold to thereby sell the subscription to the customer;
sending the request to set up a subscription service instance for the subscription between the merchant and the customer to the universal gateway to thereby handle recurring payments corresponding to the subscription by the customer; and
receiving, by the one or more processors, from the universal gateway, an acknowledgement that the subscription service instance has been successfully set up corresponding to the request for the subscription service instance.

6. The computer implemented method of claim 1, further comprising:
based on ascertaining that the credit evaluation for the customer does not satisfies the predefined credit threshold on the subscription for sale by the merchant, prompting the merchant for an input inquiring if the merchant would override the predefined credit threshold for the subscription, by displaying the credit evaluation for the customer along with a request for the input;
obtaining, from the merchant, the input indicating that the merchant would not interfere with the predefined credit threshold thereby not to sell the subscription to the customer; and
terminating inquiries on the subscription for the customer with the universal gateway.

7. The computer implemented method of claim 1, further comprising:
upon due dates respective to the recurring payments corresponding to the subscription, iteratively receiving a notification with a payment status on a current recurring payment from the universal gateway.

8. A computer implemented method comprising:
receiving, by one or more processors of a universal gateway, a request for a credit evaluation for a customer from a merchant device amongst one or more merchant devices run by a merchant, the merchant device being operatively coupled to the universal gateway via a digital communication network;
sending, by the one or more processors, the credit evaluation for the customer to the merchant device, based on completing a back-end processing for the credit evaluation with an open banking partner operatively coupled to the universal gateway;
obtaining, by the one or more processors, a request from the merchant device for a subscription service instance to handle recurring payments corresponding to the subscription for the merchant by the customer; and
sending, by the one or more processors, an acknowledgement, to the merchant device, that the subscription service instance is successfully set up for handling the recurring payments, based on completing with setup of the subscription service instance for the merchant by the customer based on a universal token integrating payment card information and banking information of the customer.

9. The computer implemented method of claim 8, wherein the request for the credit evaluation comprises personal identification information, payment card information, and banking information, respectively corresponding to the customer.

10. The computer implemented method of claim 8, the back-end processing for the credit evaluation comprising:
creating a customer account for the customer;
tokenizing the payment card information and the banking information corresponding to the customer into the universal token;
inquiring the open banking partner for the credit evaluation for the customer with the universal token; and
obtaining the credit evaluation corresponding to the universal token from the open banking partner.

11. The computer implemented method of claim 8, wherein the request for the subscription service instance received from the merchant device to handle the recurring payments corresponding to the subscription for the merchant by the customer comprises respective values for an amount for the recurring payments, due dates for the recurring payments, a bank account number for a debit payment, and a payment card account number for a credit payment based on inputs by the merchant on the merchant device as provided by the customer.

12. The computer implemented method of claim 8, further comprising:
prior to the sending the acknowledgement of the subscription service instance, creating the subscription service instance based on respective values for an amount for the recurring payments corresponding to the subscription, due dates for the recurring payments, a bank account number for a debit payment for the recurring payments, and a payment card account number for a credit payment for the recurring payments;
updating the universal token created upon the credit evaluation with the bank account number and the payment card account number set for the subscription service instance; and
associating the customer account for the customer created upon the credit evaluation with the universal token resulting from the updating the universal token.

13. The computer implemented method of claim 8, further comprising:
while the subscription is effective, upon respective due dates for each of the recurring payments corresponding to the subscription, iteratively performing:
charging, by a subscription service instance for the subscription running on the universal gateway, the open banking partner of the universal token for an amount of a current recurring payment on a scheduled date;
receiving, by the subscription service instance, a payment status on the current recurring payment from the open banking partner;
based on ascertaining, by the subscription service instance, that the payment status indicates that the current recurring payment had been successfully paid, sending a notification with the payment status on the current recurring payment to the merchant device, by the subscription service instance.

14. The computer implemented method of claim 8, further comprising:
while the subscription is effective, upon respective due dates for each of the recurring payments corresponding to the subscription, iteratively performing:
charging, by a subscription service instance for the subscription running on the universal gateway, the open banking partner of the universal token for an amount of a current recurring payment on a scheduled date;
receiving, by the subscription service instance, a payment status on the current recurring payment from the open banking partner;
based on ascertaining, by the subscription service instance, that the payment status indicates that the current recurring payment had not been successfully paid, charging the payment network of the universal token for the amount of the current recurring payment by the subscription service instance;
receiving, by the subscription service instance, a credit payment status on the current recurring payment from the payment network of the universal token; and
sending a notification with the credit payment status on the current recurring payment to the merchant device.

15. The computer implemented method of claim 8, further comprising:
while the subscription is effective, upon respective due dates for each of the recurring payments corresponding to the subscription, iteratively performing:
charging, by a subscription service instance for the subscription running on the universal gateway, the open banking partner of the universal token for an amount of a current recurring payment on a scheduled date;
receiving, by the subscription service instance, a debit payment status on the current recurring payment from the open banking partner;
based on ascertaining, by the subscription service instance, that the debit payment status indicates that the current recurring payment had not been successfully paid, charging the payment network of the universal token for the amount of the current recurring payment by the subscription service instance;
receiving, by the subscription service instance, a credit payment status on the current recurring payment from the payment network of the universal token; and
sending a notification with the debit payment status and the credit payment status on the current recurring payment to the merchant device.

16. The computer implemented method of claim 8, further comprising:
while the subscription is effective, upon respective due dates for each of the recurring payments corresponding to the subscription, iteratively performing:
charging, by a subscription service instance for the subscription running on the universal gateway, an alternative payment account of the customer comprising a reward point account and a gift card account as offered by the merchant or another merchant affiliated for payment exchange of the universal token for an amount of a current recurring payment on a scheduled date, wherein the universal token comprises the alternative payment account of the customer as provided by the customer or the merchant in relation with the subscription service instance.

17. A system comprising:
a merchant device amongst one or more merchant devices for a merchant to access a payment service, wherein the merchant device is located at a retail store of the merchant, and wherein the merchant provides a retail product for sale to be purchased by a customer at the retail store by a subscription associated with recurring payments;
a universal gateway configured to provide, to the merchant device, the payment service, a subscription service to handle the recurring payments corresponding to the subscription, a token service to integrate financial information of the customer into a universal token for credit evaluation and payments, and a customer service to create and manage a customer account for the customer with respect to the subscription and the universal token;
one or more payment networks operatively coupled to the universal gateway for credit transactions requested from the merchant device; and
one or more open banking partners operatively coupled to the universal gateway for banking transactions requested from the merchant device.

18. The system of claim 17, wherein the universal gateway is further configured to:
charge the open banking partner of the universal token for an amount of a current recurring payment on a scheduled date while the subscription is effective;
receive a payment status on the current recurring payment from the open banking partner;
based on ascertaining that the payment status indicates that the current recurring payment had been successfully paid, send a notification with the payment status on the current recurring payment to the merchant device.

19. The system of claim 17, wherein the universal gateway is further configured to:
charge the open banking partner of the universal token for an amount of a current recurring payment on a scheduled date while the subscription is effective;
receive a payment status on the current recurring payment from the open banking partner;
based on ascertaining that the payment status indicates that the current recurring payment had not been successfully paid, charge the payment network of the universal token for the amount of the current recurring payment;
receive a credit payment status on the current recurring payment from the payment network of the universal token; and
send a notification with the credit payment status on the current recurring payment to the merchant device.

20. The system of claim 17, wherein the universal gateway is further configured to:
charge the open banking partner of the universal token for an amount of a current recurring payment on a scheduled date while the subscription is effective;
receive a debit payment status on the current recurring payment from the open banking partner;
based on ascertaining that the debit payment status indicates that the current recurring payment had not been successfully paid, charge the payment network of the universal token for the amount of the current recurring payment;
receive a credit payment status on the current recurring payment from the payment network of the universal token; and
send a notification with the debit payment status and the credit payment status on the current recurring payment to the merchant device.
